(19) United States
(12) Patent Application Publication
(10) Pub. No.: US 2012/0206579 A1
(43) Pub. Date: Aug. 16, 2012

(54) THREE-DIMENTIONAL VIDEO PROCESSING DEVICE FOR GENERATING BACKLIGHT CONTROL SIGNAL TO REDUCE CROSSTALK, AND RELATED THREE-DIMENTIONAL VIDEO SYSTEM USING BACKLIGHT CONTROL AND CONTROL CIRCUIT

(76) Inventors: Chung-Wen Wu, Yilan County (TW); Wen-Hsuan Lin, New Taipei City (TW); Chia-Chun Liu, Hsinchu County (TW); Sih-Ting Wang, Kaohsiung City (TW)

(21) Appl. No.: 13/089,335

(22) Filed: Apr. 19, 2011

(30) Foreign Application Priority Data
Feb. 15, 2011 (TW) 100104885

(51) Int. Cl. H04N 13/04

(52) U.S. Cl. 348/51; 348/E13.059

(57) ABSTRACT

A three-dimensional (3D) video processing device capable of avoiding crosstalk between adjacent frames includes a video processing circuit and a control circuit. The video processing circuit is configured to generate a 3D video signal having a first frame timing. The 3D video signal is used to control a panel to update, to thereby display 3D video frames in accordance with a second frame timing which is a delayed version of the first frame timing. The control circuit is utilized for generating a backlight control signal. A switching timing of the backlight control signal is determined according to the second frame timing.

### BACKGROUND OF THE INVENTION

1. Field of the Invention

The present invention relates to three-dimensional (3D) video processing, and more particularly, to a 3D video processing device capable of avoiding or reducing crosstalk between adjacent frames, and to a 3D video system applying the same.

2. Description of the Prior Art

With the science development and technology advancement, users are no longer pursing just high resolution but more stereoscopic and vivid images. Two stereoscopic image display techniques are prevailing at present. One requires glasses, such as anaglyph glasses, polarization glasses or shutter glasses, in collaboration with a video output device, while the other solely requires the video output device without any auxiliary glasses. No matter which technique is adopted, the primary principle of stereoscopic image display is to make the left eye and the right eye see different images, such that the brain comprehends the seen images as a stereoscopic image.

Taking shutter glasses for example, two shutter lens are properly turned on or off according to the video content for allowing user's left eye to see corresponding left-eye images and user's right eye to see corresponding right-eye images. Under such an operational scenario, the user's left eye may see part of the right-eye image and/or the user's right eye may see part of the left-eye image if the turn-on periods of the shutter lenses are not adequately arranged. This results in the so-called crosstalk phenomenon that would degrade the quality of the stereoscopic images viewed by the user.

In addition to the inaccurate control of the shutter glasses, one contributing cause for the crosstalk lies in an inherent drawback of the liquid crystal display (LCD) technology. Current three-dimensional (3D) video systems oftentimes employ LCD apparatuses as the video output devices. As well-known in the industry, an LCD apparatus controls the light transmission levels by using electric field to rotate the liquid crystal (LC) cells, and then utilizes red, blue, and green filters to present different colors. The electrical characteristic of an LC cell is equivalent to that of a capacitor. When the LC cell is charged to display a grayscale, the LC cell will stay at a charged electric potential, and wait for next refreshing (i.e., another grayscale) to be reset to another charged electric potential after a period of time is expired. In addition, a typical LCD apparatus is consisted of millions of LC cells arranged in a matrix fashion that have to be refreshed column by column sequentially or interlacedly. In such a situation, if the LCD apparatus has an imprecise refresh rate or the LC cells appear to be more capacitive, a viewer may be very likely to see ghost shadows. More specifically, the ghost shadows result from the fact that the viewer's left eye sees the right-eye image when the shutter glasses have the left-eye lens turned on and the right-eye lens turned off, and while the right-eye image has not disappeared entirely. Such ghost-shadow phenomenon caused by the left eye seeing the right-eye image or the right eye seeing the left-eye image is the crosstalk.

In order to avoid the occurrence of crosstalk, black frame insertion technique may be employed to ameliorate the situation. The black frame insertion technique is a commonly used image processing technique, and the basic concept thereof is to insert a black frame in between two consecutive frames, allowing the LC cells to be reset once between two refreshing operations and thereby improving ghost-shadow and blur.

Please refer to FIG. 1, which is a schematic diagram of the black frame insertion technique applied to a 3D display system using shutter glasses. As shown in FIG. 1, an LCD apparatus displays frames 102 to 116 in order, wherein the frames 102, 110 correspond to a left-eye vision, the frames 106, 114 correspond to a left-eye vision, and the frames 104, 108, 112, 116 are black frames. In FIG. 1, time period t_{V} denotes a display time of each frame on the LCD apparatus. The shutter glasses 120 control a left-eye lens and a right-eye lens to be turned on or off in coordination with the displayed frames. As shown in FIG. 1, when the left-eye frames 102, 110 are displayed, the shutter glasses 120 turn on the left-eye lens and turn off the right-eye lens, and the viewer can only see the left-eye frames 102 through the left eye, 110. When the right-eye frames 106, 114 are displayed, the shutter glasses 120 turn on the right-eye lens and turn off the left-eye lens, and the viewer can only see the right-eye frames 102, 110 through the right eye.

Nevertheless, inserting a black frame after each frame means that the number of the displayed frames is doubled; in other words, the viewer sees not only just half amount of the original frames but also just half grayscale. To compensate for the image quality loss, the black frame insertion technique requires a double or higher refresh rate, and meanwhile the employed shutter glasses also have to be adjusted to accommodate to such rapid refreshing operation. In this way, the hardware requirement is increased greatly, which inevitably increases the production cost.

Besides, human eyes cannot perceive a long duration of a black frame without seeing flickers. As for the receptivity according to human eyes, a black frame can only last for 3˜5% of the display time of a complete frame. In this scenario, due to the short duration allowed for displaying the black frame, the LC cells may not be fully reset prior to the display of the next frame. That is to say, a user would still see a fraction of ghost shadows even if the black frame insertion technique is employed.

Therefore, the 3D display technology with the black frame insertion technique requires specialized equipments, which increases the production cost, and still fails to effectively solve the problem caused by the ghost shadow.

### SUMMARY OF THE INVENTION

One of the objectives of the present invention is therefore to provide a three dimensional (3D) video processing device capable of avoiding or reducing crosstalk between adjacent frames and related 3D video system and control circuit.

According to one aspect of the present invention, an exemplary 3D video processing device is disclosed. The exemplary 3D video processing device includes a video processing circuit and a control circuit. The video processing circuit is configured to generate a 3D video signal having a first frame timing. The 3D video signal controls a panel to update, to thereby display 3D video frames in accordance with a second frame timing which is a delayed version of the first frame timing. The control circuit is utilized for generating a backlight control signal. A switching timing of the backlight control signal is determined according to the second frame timing.

According to another aspect of the present invention, an exemplary 3D video processing device is disclosed. The exemplary 3D video processing device includes a video processing circuit and a control circuit. The video processing circuit is configured to generate a 3D video signal and a synchronization signal. The control circuit is configured to generate a backlight control signal according to the synchronization signal. The synchronization signal is associated with a first frame timing of the 3D video signal.

According to yet another aspect of the present invention, an exemplary 3D video system is disclosed. The exemplary 3D video system includes a video processing circuit, a panel, a control circuit and a backlight. The video processing circuit is configured to generate a 3D video signal having a first frame timing. The panel is updated to display 3D video frames in accordance with a second frame timing by receiving the 3D video signal. The control circuit is configured to generate a backlight control signal. The backlight is configured to receive the backlight control signal. The second frame timing is a delayed version of the first frame timing. A switching timing of the backlight control signal is determined according to the second frame timing. The backlight is turned on or off under control of the backlight control signal.

According to yet another aspect of the present invention, an exemplary 3D video system is disclosed. The exemplary 3D video system includes a video processing circuit, a panel, a control circuit and a backlight. The video processing circuit is configured to generate a 3D video signal and a synchronization signal. The panel is configured to display 3D video frames according to the 3D video signal. The control circuit is configured to generate a backlight control signal according to the synchronization signal. The backlight is configured to receive the backlight control signal. The synchronization signal is associated with a first frame timing of the 3D video signal. The backlight is turned on or off under control of the backlight control signal.

According to yet another aspect of the present invention, an exemplary control circuit for a 3D video system is disclosed. The control circuit includes a synchronization block, a delay block and a backlight control block. The synchronization block is configured to receive a synchronization signal which defines a first frame timing of a 3D video. The delay block is configured to generate a control signal according to the first frame timing and a delay time. The backlight control block is configured to generate a backlight control signal according to the control signal. The control signal defines a switching timing. The backlight control signal controls a backlight to be turned on or off according to the switching timing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the conventional black frame insertion technique applied to a 3D display system using shutter glasses.

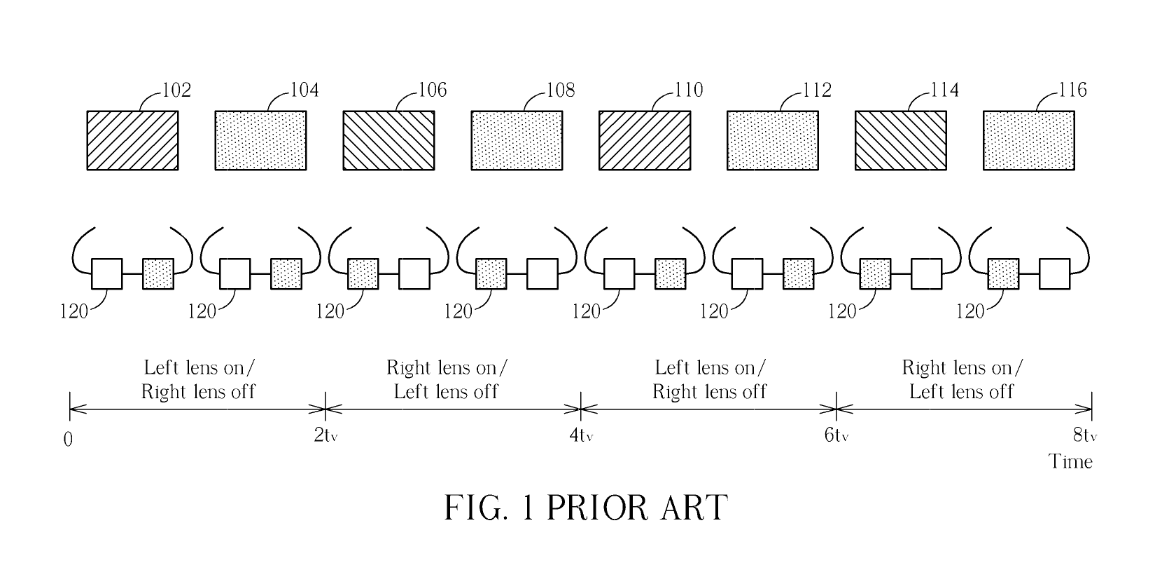

FIG. 2A is a block diagram of a three-dimensional video system according an embodiment.

FIG. 2B is a schematic diagram illustrating related waveforms of a three-dimensional video system according to an embodiment.

FIG. 3 is a schematic diagram of a control circuit according to a preferred embodiment.

### DETAILED DESCRIPTION

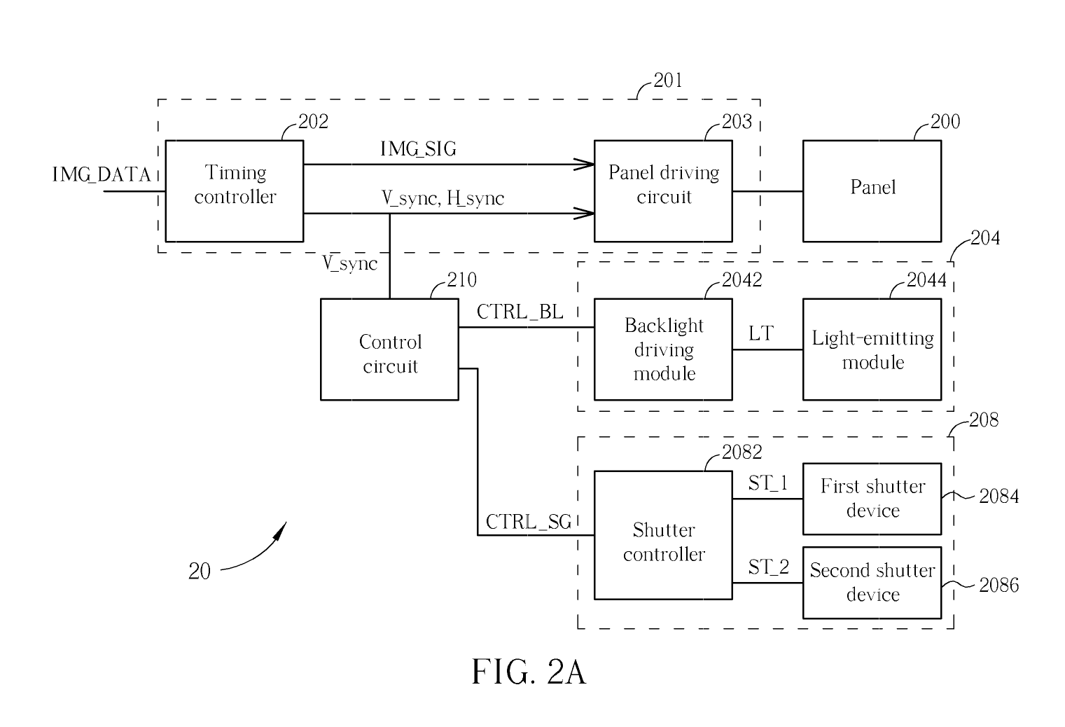

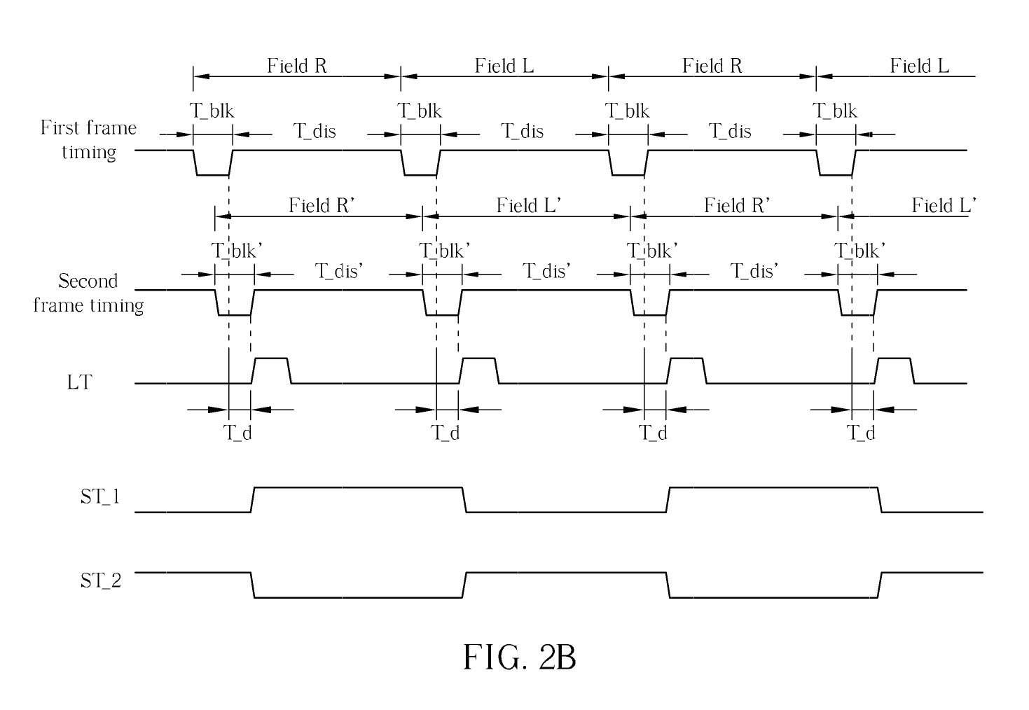

Please refer to FIG. 2A, which is a block diagram of a three-dimensional (3D) video system 20 according an embodiment. The 3D video system 20 includes a video processing circuit 201, a panel 200 (e.g., an LCD panel), a backlight 204 and a control circuit 210. The video processing circuit 201 includes a timing controller 202 and a panel driving circuit 203. When handling an image data IMG_DATA output from a video source, the timing controller 202 processes the image data IMG_DATA and then outputs a corresponding 3D video signal IMG_SIG to the panel driving circuit 206. The panel driving circuit 206 accordingly drives the panel 200 to display corresponding video frames. Besides, the timing controller 202 further outputs a vertical synchronization signal V_sync and a horizontal synchronization signal H_sync to the panel driving circuit 206, and the panel driving circuit 206 accordingly drives the panel 200 to display corresponding 3D video frames. The horizontal synchronization signal H_sync is related to an updating frequency of pixels on each row of the panel 200, whereas the vertical synchronization signal V_sync is related to an updating frequency of each frame. To put this another way, in the embodiment, the vertical synchronization signal V_sync is used to define a frame timing of the 3D video signal IMG_SIG. Note that, after the panel 200 receives the 3D video signal IMG_SIG, an LC cell thereof needs some time to progress from refreshing of the LC cell to displaying of the 3D video frame. Therefore, the 3D video signal IMG_SIG defined herein has a first frame timing, while the 3D video frames displayed by the updated panel 200 have a second frame timing, where the second frame timing is a delayed version of the first frame timing, with a delay interval determined by a liquid crystal cell response time required for updating the panel 200.

In addition, the backlight 204 includes a backlight driving module 2042 and a light-emitting module 2044. The light-emitting module 2044 may be implemented by a light-generating device, such as a light emitting diode (LED) or a cold cathode fluorescent lamp (CCFL). The backlight driving module 2042 is configured to generate a backlight driving signal LT to control the on/off status of the light-emitting module 2044.

In order to control the on/off status of the backlight 204, the vertical synchronization signal V_sync generated by the timing controller 202 is further output to the control circuit 210. The control circuit 210 accordingly generates a backlight control signal CTRL_BL to the backlight driving module 2042. The backlight driving module 2042 therefore generates the backlight driving signal LT according to the backlight control signal CTRL_BL. Both of the backlight control signal CTRL_BL and the backlight driving signal LT may periodically switch between a turn-on state and a turn-off state, to thereby control the light-emitting module 2044 to be turned on and off.

Note that, as mentioned previously, since the second frame timing at which the 3D video frames are displayed by the updated panel 200 lags behind the first frame timing of the 3D video signal IMG_SIG, a switching timing of the backlight control signal CTRL_BL is preferably configured in accordance with the second frame timing. To achieve this goal, in a preferred embodiment, the control circuit 210 generates the backlight control signal CTRL_BL according to both the first frame timing defined by the vertical synchronization signal V_sync and the liquid crystal cell response time required for updating the panel 200 in the process of generating the backlight control signal CTRL_BL. In this way, the switching timing of the backlight control signal CTRL_BL may be defined by the second frame timing.

Please refer to FIG. 2B for better comprehension of the correlation among the first frame timing of the 3D video signal IMG_SIG, the second frame timing of the 3D video frames displayed by the updated panel 200 and the switching timing of the backlight driving signal LT in FIG. 2A. FIG. 2B is a schematic diagram illustrating related waveforms of the 3D video system 20 according to an embodiment. Note that, since the switching timing of the backlight driving signal LT corresponds to the switching timing of backlight control signal CTRL_BL, the switching timing of the backlight control signal CTRL_BL may be readily derived from the illustration of FIG. 2B. Further description is therefore omitted here for brevity.

As shown in FIG. 2B, the 3D video frames displayed by the updated panel 200 are consisted of alternate right-eye frames Field_R and left-eye frames Field_L. Similarly, the 3D video signal IMG_SIG is consisted of alternate right-eye frames Field_R′ and left-eye frames Field_L′. Nevertheless, the second frame timing of the 3D video frames is the delayed version of the first frame timing the 3D video signal IMG_SIG. In addition, to avoid crosstalk caused by constantly turned-on backlight, the backlight 204 may be configured to periodically switch between a turn-on state and a turn-off state in response to frame-to-frame transitions. Preferably, during each frame cycle defined by the second frame timing, the backlight driving signal LT (or the backlight control signal CTRL_BL) is turned on, i.e., switched from the turn-off state (e.g., a low-voltage level state) to the turn-on state (e.g., a high-voltage level state). The number of times of a turn-on state transition in each frame is preferably one. In this way, when the backlight 204 is turned on, the panel 200 has finished updating, such that a user would not see some in-transition part of a preceding frame corresponding to the other eye and thus no crosstalk would result from the preceding frame occurs.

More specifically, as shown in FIG. 2B, display periods T_dis of two successive frames of the 3D video signal IMG_SIG are separated by a vertical blanking period T_blk. Similarly, display periods T_dis' of two successive frames of the 3D video frames displayed by the panel 200 are separated by a vertical blanking period T_blk'. To effectively prevent the crosstalk, preferably, the backlight driving signal LT may be configured to stay at the turn-on state in the beginning of the display periods T_dis' of the 3D video frames or during the display periods T_dis' of the 3D video frames, and to stay at the turn-off state during at least a partial display periods T_dis'. In an alternative embodiment, the turn-on time points of the backlight 204 can be advanced (i.e., the backlight driving signal LT may be configured to be additionally turned on at the last phase of the preceding blanking period T_blk'). The alternative embodiment increases brightness of the displayed frames, but has less immunity against the crosstalk. In short, the turn-on time points of the backlight 204 may be configured according to actual design consideration. When the backlight 204 is turned on earlier, the displayed frame would have higher brightness at the expense of the immunity against the crosstalk.

Similarly, turn-off time points of the backlight 204 are also configurable in accordance with the actual design consideration. When the backlight 204 is turned off later, the displayed frame would have higher brightness at the expense of the immunity against the crosstalk. Preferably, the backlight driving signal LT is configured to be turned off during the display period T_dis′ of the same frame. To put it another way, each duration in which the backlight control signal LT stays at the turn-on state resides in a single frame cycle (i.e., the backlight driving signal LT stays at the turn-on state for less than the display periods of two successive frames Field_R′ and Field_L′). Therefore, the backlight 204 is turned off prior to the beginning of the next frame corresponding to the other eye's vision, such that the user would not be able to see the next frame and thus no crosstalk would result from the next frame occurs.

However, note that, the duration in which the backlight 204 stays at the turn-on state is not limited to residing in a single frame cycle. For example, in other embodiments, the turn-off time points of the backlight 204 is slightly postponed (i.e., the backlight driving signal LT may be configured to stay at the turn-on state at the beginning phase of the blanking period T_blk′ of the next frame.) This sort of embodiments increases the brightness of the displayed frames, but has less immunity against the crosstalk.

To sum up, the duration in which the backlight 204 stays at the turn-on state may reside in a display period of a single frame to achieve the best video quality, or at most slightly extends forward to the blanking interval of the next frame or extends backward to the blanking interval of the same frame, which slightly sacrifices the immunity against the crosstalk. However, no matter whichever means is used, each duration in which the backlight 204 stays at the turn-on state spans less than display periods of two successive frames. Therefore, the user would not see ghost-shadow images resulting from either of the preceding frame and the next frame. The crosstalk resulting from the preceding frame and the next frame is reduced effectively.

The following embodiments provide more detail and elaborate descriptions of the turn-on time points of the backlight 204. Firstly, regarding the correlation between the second frame timing and the backlight driving signal LT, the turn-on time points of the backlight driving signal LT may be configured to fall at or behind the start points of the display periods T_dis' of the second frame timing. More specifically, during each frame cycle defined by the second frame timing, if the 3D video frame is switched from the blanking period T_blk to the display period T_dis at a first switching time point, and the backlight driving signal LT is switched from the turn-off state to the turn-on state at a second switching time point, the second switching time point may be substantially equivalent to or fall behind the first switching time point. Note that, FIG. 2B illustrates an example in which the first time point is equivalent to the second time point.

In addition, regarding the correlation between the first frame timing and the backlight driving signal LT, the turn-on time points of the backlight driving signal LT may be configured to fall behind the start points of display periods T_dis of the first frame timing. In this way, the backlight driving signal LT needs an additional delayed time T_d following the blanking period T_blk, to progress to the turn-on state. Generally speaking, as long as the delayed time T_d is longer than the liquid crystal cell response time required for updating the panel 200, the user would not see the crosstalk.

To sum up, due to the inherent characteristic of the LC cell, the panel 200 needs a response time to update the 3D video frames. Therefore, the backlight 204 is turned on after the panel 200 finishes updating the displayed frames. For example, the backlight 204 is turned on during the display periods T_dis' of the 3D video frames or turned on at a slightly earlier time point during the blanking period T_blk' of the same frame. In this way, the user would not see the in-transition part of a preceding frame, and the crosstalk resulting from the preceding frame is reduced effectively. Besides, the backlight 204 may be further configured to be turned off before the start point of the blanking period T_blk′ of the next frame of the 3D video frames, or turned off at a slightly later time point before the start point of the display period T_dis′ of the next frame. In this way, the user would not see the ghost-shadow images resulting from the next frame, and the crosstalk is reduced effectively.

Please refer to FIG. 2A again. As shown in FIG. 2A, the 3D video system 20 in some embodiments further includes shutter glasses 208. The shutter glasses 208 are used for alternately blocking the left-eye vision and the right-eye vision, to thereby present 3D video for the viewer. For example, the shutter glasses 208 include a first shutter device 2084, a second shutter device 2086 and a shutter controller 2082. The first shutter device 2084 corresponds to the left-eye vision, while the second shutter device 2086 corresponds to the right-eye vision. The shutter controller 2082 is used to generate shutter driving signals ST_1 and ST_2 to control the first shutter device 2084 and the second shutter device 2086, respectively.

To control the operation of the shutter glasses 208, the control circuit 210 further generates a shutter glasses control signal CTRL_SG to the shutter controller 2082, such that the shutter controller 2082 accordingly generates the shutter driving signals ST_1 and ST_2. It should be noted that the operation of the shutter glasses control signal CTRL_SG and the shutter driving signals ST_1, ST_2 should preferably accommodate to the operation of the backlight 204. To this end, the control circuit 210 may be configured to generate the shutter glasses control signal CTRL_SG according to the switching timing of the backlight control signal CTRL_BL.

Please refer to FIG. 2B again. FIG. 2B also illustrates the shutter driving signals ST_1 and ST_2 for a more comprehensive elaboration of the correlation among the shutter driving signals ST_1, ST_2 and other signals in FIG. 2A. Please note that, since the switching timing of the shutter driving signals ST_1, ST_2 corresponds to the switching timing of the shutter glasses control signal CTRL_SG, the switching timing of the shutter glasses control signal CTRL_SG should be readily known by referring to pertinent description of FIG. 2B, and further description is therefore omitted here for brevity.

As shown in FIG. 2B, the shutter glasses 208 is switched from one eye vision to the other eye vision before the backlight driving signal LT is switched to the turn-on state, and is switched from the other eye vision to the one eye vision after the backlight driving signal LT is switched to the turn-off state. More specifically, as to any of the shutter driving signals ST_1, ST_2 and the shutter glasses control signal CTRL_SG, there are a plurality of turn-on time points respectively residing before corresponding turn-on time points of the backlight driving signal LT (or the backlight control signal CTRL_BL), and a plurality of turn-off time points respectively residing after corresponding turn-off time points of the backlight driving signal LT (or the backlight control signal CTRL_BL). In the above-mentioned configuration, the operation of the shutter glasses 208 can accommodate to the operation of the backlight 204, thereby avoiding the crosstalk.

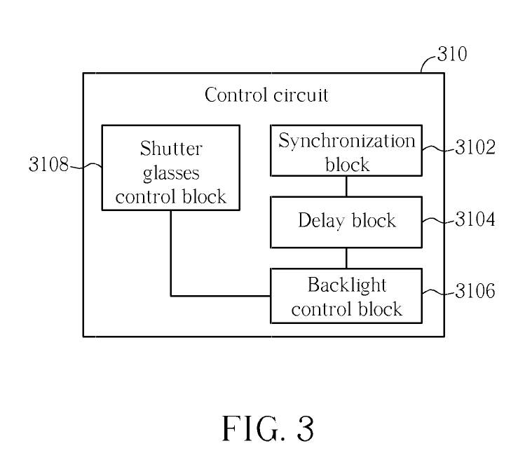

Please refer to FIG. 3, which is a schematic diagram of a control circuit 310 according to a preferred embodiment. The control circuit 310 is utilized for implementing the control circuit 210 shown in FIG. 2A. The control circuit 310 includes a synchronization block 3102, a delay block 3104, a backlight control block 3106. The synchronization block 3102 is configured to receive a synchronization signal (e.g., the vertical synchronization signal V_sync generated by the time controller 202) and accordingly defining the first frame timing. The delay block 3104 is configured to receive the vertical synchronization signal V_sync, and generating a control signal CTRL according to the first frame timing and an updating time of the panel 200 (including the liquid crystal cell response time), where the control signal CTRL defines the switching timing of the backlight control signal CTRL_BL. The backlight control block 3106 is configured to generate the backlight control signal CTRL_BL according to the control signal CTRL, where the backlight 204 is turned on or turned off according to the switching timing of the backlight control signal CTRL_BL. In addition, the control circuit 310 further includes a shutter glasses control block 3108 used for generating a shutter glasses control signal CTRL_SG according to the switching timing of the backlight control signal CTRL_BL. As correlation among said signals may be readily known from FIG. 2A and FIG. 2B, further description is therefore omitted here for brevity.

Please note that, in different embodiments of the control circuit 310, the shutter glasses control block 3108 may use one of the vertical synchronization signal V_sync, the control signal CTRL and the backlight control signal CTRL_BL to generate the shutter glasses control signal CTRL_SG, and is not limited to receiving the backlight control signal CTRL_BL to generate the shutter glasses control signal CTRL_SG. In addition, the backlight control block 3106 and the shutter glasses control block 3108 shown in FIG. 3 may be integrated into one block or independently disposed; alternatively, the backlight control block 3106 and the shutter glasses control block 3108 may be integrated into/independently disposed in different devices/circuit blocks, respectively.

Besides, please note that the exemplary embodiment shown in FIG. 2A is merely for illustrative purposes, and alternations and modifications made without departing from the spirit of the present invention should still fall within the scope of the present invention. For example, regarding the exemplary embodiment shown in FIG. 2A, the time controller 202 needs to feed the vertical synchronization signal V_sync and the horizontal synchronization signal H_sync to the panel driving circuit 206. However, in other exemplary embodiments, the 3D video signal IMG_SIG itself may contain frame-timing information. Therefore, the panel driving circuit 206 may operate normally according to the 3D video signal IMG_SIG without receiving the vertical synchronization signal V_sync and the horizontal synchronization signal H_sync.

Besides, please note that the aforementioned control circuit 210 receives the vertical synchronization signal V_sync generated by the time controller 202. However, the present invention is not limited to such an implementation. The control circuit 210 is allowed to receive any synchronization signal as long as the provided synchronization signal has information of the first frame timing of the 3D video signal IMG_SIG or the second frame timing of the 3D video frames.

Moreover, please note that the aforementioned embodiments have various implementations. For example, the video processing circuit 201 may not require both the time controller 202 and the panel driving circuit 206, and the time controller 202 or the panel driving circuit 206 may be disposed separately as different video processing circuits. To put it another way, the video processing circuit 201 only requires either the time controller 202 or the panel driving circuit 206 and is capable of providing the synchronization signal. Furthermore, the control circuit 210 may be integrated into or disposed in different devices. For example, the control circuit 210 may be integrated into the time controller 202 or the panel driving circuit 206. In the different embodiments, communication between the backlight 204 and the control circuit 210, or communication between the control circuit 210 and various video processing circuits which provide the synchronization signal may be realized via wired or wireless communication means, such as physical lines, infrared signals, radio-frequency (RF) signals, etc.

In addition, the backlight control block 3106 and the shutter glasses control block 3108 shown in FIG. 3 may be integrated into one block or disposed independently. Alternatively, the backlight control block 3106 and the shutter glasses control block 3108 may be disposed or integrated in different devices or circuit blocks, respectively. For example, either of the backlight control block 3106 and the shutter glasses control block 3108 may be integrated into the time controller 202 or the panel driving circuit 206, or the backlight control block 3106 and the shutter glasses control block 3108 may be disposed in the backlight 204 and the shutter glasses 208, respectively. In different embodiments, communication between the backlight 204/shutter glasses 208 and the control circuit 210, or communication between the backlight control block 3106/shutter glasses control block 3108 and the various video processing circuits which provide the synchronization signal, or communication between the shutter glasses control block 3108 and the backlight control block 3106 may be realized via wired or wireless communication means, such as physical lines, infrared signals, RF signals, etc.

On the other hand, the time controller 202 in the 3D video system 20 may also adopt the black frame insertion technique to enhance the 3D video display, which has no conflicts with the control circuit 210 and does not affect the operation of the control circuit 210. In addition, the backlight driving module 2042 not only controls the on/off status of the light-emitting module 2044 according to the backlight control signal CTRL_BL, but also controls the light intensity level (i.e., the brightness) or activation time of the light-emitting module 2044 according to the signal generated by the time controller 202. The above-mentioned embodiments may be adjusted or modified, depending upon the actual design requirement/consideration.

To sum up, in the prior art design, the backlight is not periodically turned on or off; instead, the backlight is constantly turned on during playback of successive frames (i.e., a duration in which the backlight is turned on spans more than display periods of two successive frames). Thus, a user may often perceive crosstalk between the left-eye frames and the right-eye frames. In contrast to the prior art design, the above-mentioned embodiments can control the backlight according to the refresh rate, such that the backlight is turned on after an LCD panel finishes updating the display of each frame. Besides, each duration in which the back light is turned on can span less than the display periods of two consecutive frames. In this way, as the user would not see in-transition images, the crosstalk can be effectively reduced or avoided, and the 3D video display quality can be improved.

Those skilled in the art will readily observe that numerous modifications and alterations of the device and method may be made while retaining the teachings of the invention.

What is claimed is:

1. A three-dimensional (3D) video processing device, comprising:
a video processing circuit, configured to generate a 3D video signal having a first frame timing, wherein the 3D video signal is utilized for controlling a panel to update, so as to display 3D video frames in accordance with a second frame timing which is a delayed version of the first frame timing; and
a control circuit, configured to generate a backlight control signal, wherein a switching timing of the backlight control signal is determined according to the second frame timing.

2. The 3D video processing device of claim 1, wherein the backlight control signal is switched from a turn-off state to a turn-on state during each frame cycle defined by the second frame timing.

3. The 3D video processing device of claim 2, wherein each duration in which the backlight control signal staying at the turn-on state spans less than display periods of two successive frames.

4. The 3D video processing device of claim 1, wherein each frame cycle defined by the second frame timing comprises a blanking period and a display period, and the backlight control signal stays at the turn-on state during at least a partial display period of each frame.

5. The 3D video processing device of claim 4, wherein the backlight control signal further stays at the turn-on state during a partial blanking period of the same frame or an adjacent frame.

6. The 3D video processing device of claim 1, wherein during each frame cycle defined by the second frame timing, the 3D video frame is switched from a blanking period to a display period at a first switching time point, and the backlight control signal is switched from a turn-off state to a turn-on state at a second switching time point, wherein the second switching time point substantially equals or lags behind the first switching time point.

7. The 3D video processing device of claim 1, wherein the control circuit generates the backlight control signal according to the first frame timing of the 3D video signal and a delay time.

8. The 3D video processing device of claim 7, wherein the delay time is determined by a liquid crystal cell response time required for updating the panel.

9. The 3D video processing device of claim 1, wherein during each frame cycle defined by the first frame timing, the 3D video frame is switched from a blanking period to a display period at a first switching time point, and the backlight control signal is switched from a turn-off state to a turn-on state at a second switching time point, wherein the second switching time point lags behind the first switching time point.

10. The 3D video processing device of claim 1, wherein the control circuit further generates a shutter glasses control signal according to one of the backlight control signal and the 3D video signal.

11. The 3D video processing device of claim 10, wherein the shutter glasses control signal has a plurality of turn-on time points located before a corresponding turn-on time point of the backlight control signal, respectively, and a plurality of turn-off time points located after a corresponding turn-off time point of the backlight control signal, respectively.

12. The 3D video processing device of claim 1, wherein the video processing circuit further generates a synchronization signal associated with the first frame timing of the 3D video signal, and the control circuit utilizes the synchronization signal to generate the backlight control signal.

13. A 3-dimensional (3D) video processing device, comprising:
a video processing circuit, configured to generate a 3D video signal and a synchronization signal, wherein the synchronization signal is associated with a first frame timing of the 3D video signal; and
a control circuit, configured to generate a backlight control signal according to the synchronization signal.

14. The 3D video processing device of claim 13, wherein the control circuit further generates the backlight control signal according to a liquid crystal cell response time.

15. The 3D video processing device of claim 13, wherein in each frame, the synchronization signal is switched from a blanking period to a display period at a first switching time point, and the backlight control signal is switched from a turn-off state to a turn-on state at a second switching time point, wherein the second switching time point lags behind the first switching time point.

16. A 3-dimensional (3D) video system, comprising:
a video processing circuit, configured to generate a 3D video signal having a first frame timing;
a panel, updated to display 3D video frames in accordance with a second frame timing by receiving the 3D video signal, wherein the second frame timing is a delayed version of the first frame timing;
a control circuit, configured to generate a backlight control signal, wherein a switching timing of the backlight control signal is determined according to the second frame timing; and
a backlight, configured to receive the backlight control signal, wherein the backlight is turned on or off under control of the backlight control signal.

17. The 3D video system of claim 16, wherein during each frame cycle defined by the second frame timing, the backlight control signal is switched from a turn-off state to a turn-on state.

18. The 3D video system of claim 17, wherein each duration in which the backlight control signal stays at the turn-on state spans less than display periods of two successive frames.

19. The 3D video system of claim 16, wherein each frame cycle defined by the second frame timing comprises a blanking period and a display period, and the backlight control signal stays at the turn-on state during at least a partial display period of each frame.

20. The 3D video system of claim 19, wherein the backlight control signal further stays at the turn-on state during a partial blanking period of the same frame or an adjacent frame.

21. The 3D video system of claim 16, wherein during each frame cycle defined by the second frame timing, the 3D video frame is switched from a blanking period to a display period at a first switching time point, and the backlight control signal is switched from a turn-off state to a turn-on state at a second switching time point, where the second switching time point substantially equals or lags behind the first switching time point.

22. The 3D video system of claim 16, wherein the control circuit generates the backlight control signal according to the first frame timing of the 3D video signal and a delay time.

23. The 3D video system of claim 22, wherein the delay time is determined by a liquid crystal cell response time required for updating the panel.

24. The 3D video system of claim 23, wherein during each frame cycle defined by the first frame timing, the 3D video frame is switched from a blanking period to a display period at a first switching time point, and the backlight control signal is switched from a turn-off state to a turn-on state at a second switching time point, where the second switching time point lags behind the first switching time point by at least the delay time.

25. The 3D video system of claim 23, wherein the control circuit further generates a shutter glasses control signal according to one of the backlight control signal and the 3D video signal.

26. The 3D video system of claim 25, further comprising shutter glasses which are turned on or off according to the shutter glasses control signal.

27. The 3D video system of claim 25, wherein the shutter glasses control signal has a plurality of turn-on time points located before a corresponding turn-on time point of the backlight control signal, respectively, and a plurality of turn-off time points located after a corresponding turn-off time point of the backlight control signal, respectively.

28. The 3D video system of claim 16, wherein the video processing circuit further generates a synchronization signal associated with the first frame timing of the 3D video signal, and the control circuit utilizes the synchronization signal to generate the backlight control signal.

29. A 3-dimensional (3D) video system, comprising:
a video processing circuit, configured to generate a 3D video signal and a synchronization signal, wherein the synchronization signal is associated with a first frame timing of the 3D video signal;
a panel, configured to display 3D video frames according to the 3D video signal;
a control circuit, configured to generate a backlight control signal according to the synchronization signal; and
a backlight, configured to receive the backlight control signal, wherein the backlight is turned on or off under control of the backlight control signal.

30. The 3D video system of claim 29, wherein the control circuit further generates the backlight control signal according to a liquid crystal cell response time.

31. The 3D video system of claim 29, wherein in each frame, the synchronization signal is switched from a blanking period to a display period at a first switching time point, and the backlight control signal is switched from a turn-off state to a turn-on state at a second switching time point, where the second switching time point lags behind the first switching time point.

32. A control circuit for a 3-dimensional (3D) video system, comprising:
a synchronization block, configured to receive a synchronization signal which defines a first frame timing of a 3D video;
a delay block, configured to generate a control signal according to the first frame timing and a delay time, wherein the control signal defines a switching timing; and
a backlight control block, configured to generate a backlight control signal according to the control signal, wherein the backlight control signal controls a backlight to be turned on or off according to the switching timing.

33. The control circuit of claim 32, wherein the delay time is determined by a liquid crystal cell response time required for updating the panel.

34. The control circuit of claim 32, further comprising:
a shutter glasses control block, configured to generate a shutter glasses control signal according to the switching timing.

35. The control circuit of claim 34, wherein the shutter glasses control block utilizes one of the synchronization signal, the control signal, and the backlight control signal to generate the shutter glasses control signal.

36. The control circuit of claim 34, wherein the shutter glasses control signal has a plurality of turn-on time points located before a corresponding turn-on time point of the backlight control signal, respectively, and a plurality of turn-off time points located after a corresponding turn-off time point of the backlight control signal, respectively.
